(19) United States
(12) Patent Application Publication
(10) Pub. No.: US 2024/0326490 A1
(43) Pub. Date: Oct. 3, 2024

(54) DETECTION DEVICE AND RECORDING DEVICE

(71) Applicant: SEIKO EPSON CORPORATION, Tokyo (JP)

(72) Inventors: Takehiro SHIN, SHIOJIRI-SHI (JP); Kentaro NAKAMURA, SHIOJIRI-SHI (JP)

(21) Appl. No.: 18/622,229

(22) Filed: Mar. 29, 2024

(30) Foreign Application Priority Data
Mar. 30, 2023 (JP) 2023-055089

(51) Int. Cl. B41J 29/02; B41J 11/26; B41J 29/393

(52) U.S. Cl. CPC B41J 29/02; B41J 11/26; B41J 29/393

(57) ABSTRACT

A detection device is a detection device that detects opening and closing of a door with respect to a device main body, including a pressing member attached to the door, a sensor attached to the device main body, and configured to detect that the door is closed by detecting the pressing member, and a switch attached to the device main body, and configured to interrupt power supply when pressing by the pressing member is released, wherein the sensor and the switch are positioned above or below the pressing member in a state where the door is closed, and positioned so as to overlap each other when viewed from a vertical direction.

The present application is based on, and claims priority from JP Application Serial Number 2023-055089, filed Mar. 30, 2023, the disclosure of which is hereby incorporated by reference herein in its entirety.

### BACKGROUND

### 1. Technical Field

The present disclosure relates to a detection device and a recording device.

### 2. Related Art

JP 2007-309955 A describes a detection device attached to a recording device. The detection device includes a sensor that detects opening and closing of a door, a switch that interrupts power supply, and a shaft member that moves in accordance with the opening and closing of the door. The sensor detects that the door is closed by detecting the shaft member. The switch interrupts the power supply when pressing by the shaft member is released.

In the detection device described in JP 2007-309955 A, the sensor and the switch are aligned in a horizontal direction in which the shaft member extends. This easily results in a large size in the horizontal direction of the detection device.

### SUMMARY

A detection device for solving the above-described problems is a detection device that detects opening and closing of a door with respect to a device main body, including a pressing member attached to the door, a sensor attached to the device main body, and configured to detect that the door is closed by detecting the pressing member, and a switch attached to the device main body, and configured to interrupt power supply when pressing by the pressing member is released, wherein the sensor and the switch are positioned above or below the pressing member in a state where the door is closed, and positioned so that the sensor and the switch overlap when viewed from a vertical direction.

A recording device for solving the above-described problems includes the above-described detection device, the device main body, and the door.

### BRIEF DESCRIPTION OF THE DRAWING

FIG. 1 is a front view illustrating an example of a recording device including a detection device.

FIG. 2 is a front view of the recording device illustrating the detection device.

FIG. 3 is a top view of the recording device.

FIG. 4 is a perspective view of a frame.

FIG. 5 is an enlarged view of FIG. 2.

FIG. 6 is a front view of a state in which a door is opened from FIG. 5.

FIG. 7 is a front view of a state in which the door is further opened from FIG. 6.

FIG. 8 is a perspective view of a pressing member.

FIG. 9 is a side view of the detection device.

### DESCRIPTION OF EMBODIMENTS

An example of a recording device including a detection device will be described below with reference to the drawings. The recording device is, for example, an inkjet printer that records images such as text and photographs by ejecting ink, which is an example of liquid, onto a medium such as paper or cloth. The recording device is not limited to the ink jet type, and a printer of toner-jet type, or a dot impact-type may be used.

### Recording Device

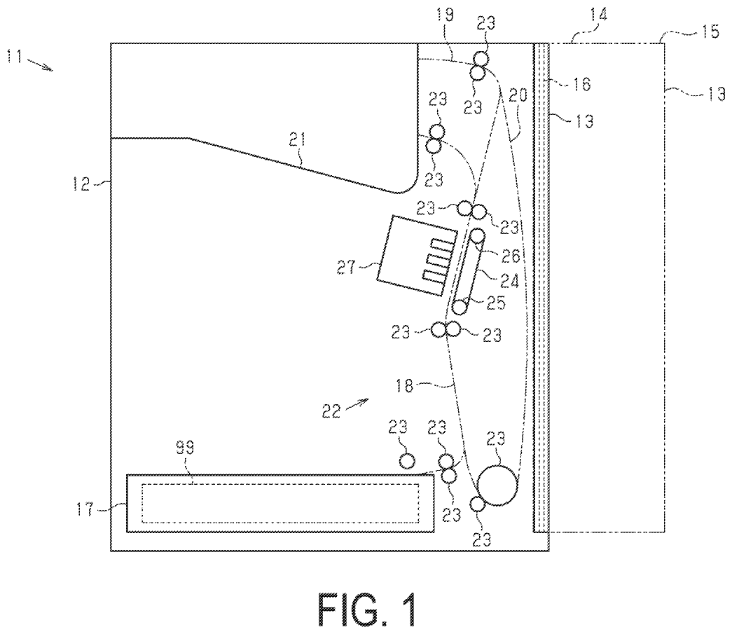

As illustrated in FIG. 1, a recording device 11 includes a device main body 12. The device main body 12 accommodates various configurations included in the recording device 11. In one example, a shape of the device main body 12 is a rectangular parallelepiped or rectangular parallelepiped- like.

The recording device 11 includes a door 13. The door 13 is attached to the device main body 12. The door 13 is attached to the device main body 12 by, for example, a hinge, a shaft, or the like. The door 13 is configured to be opened and closed with respect to the device main body 12. Specifically, the door 13 is opened and closed by rotating with respect to the device main body 12. The door 13 is positioned so as to cover a side surface of the device main body 12. The door 13 illustrated in FIG. 1 by a solid line is closed. The door 13 illustrated in FIG. 1 by a two-dot chain line is opened. When the door 13 is opened, an inside of the device main body 12 is exposed. A user can maintain the recording device 11 by opening the door 13.

The door 13 includes a proximal portion 14 and a distal end portion 15. The proximal portion 14 is a portion attached to the device main body 12. The door 13 rotates about the proximal portion 14. The distal end portion 15 constitutes an end portion of the door 13 opposite to the proximal portion 14. For example, the user opens and closes the door 13 by holding the distal end portion 15 with a hand. When the door 13 is opened and closed, the distal end portion 15 moves so as to draw an arc about the proximal portion 14.

The door 13 includes a rotational axis 16. The rotational axis 16 is an imaginary axis serving as a center of rotation of the door 13. The door 13 is opened and closed by rotating about the rotational axis 16. In one example, the rotational axis 16 extends in a vertical direction through the proximal portion 14. Therefore, the door 13 is a so-called lateral opening door that opens horizontally. The rotational axis 16 may extend in a horizontal direction through a lower end portion of the door 13 or an upper end portion of the door 13. In this case, the door 13 is vertically opened.

The recording device 11 includes a loading unit 17. The loading unit 17 is configured so that one or more medium 99 are loaded thereon. For example, the plurality of media 99 are loaded on the loading unit 17 in a state of being stacked. The loading unit 17 is attached to the device main body 12. The loading unit 17 is positioned at a lower portion of the device main body 12. In one example, the loading unit 17 is configured to be insertable into and removable from the device main body 12. The loading unit 17 is, for example, a cassette. The user can replenish the loading unit 17 with the media 99 by pulling out the loading unit 17 from the device main body 12. The loading unit 17 is not limited to a cassette and may be a tray.

Through the recording device 11, a transport path 18 extends. The medium 99 is transported through the transport path 18 in the recording device 11. The transport path 18 is a space formed by configurations included in the recording device 11. A transport direction in which the medium 99 is transported is a direction in which the transport path 18 extends. The transport path 18 extends from the loading unit 17 toward an outside of the device main body 12. An image is recorded on the medium 99 in a process of transport through the transport path 18. The medium 99 is transported through the transport path 18, to be discharged outside the device main body 12.

In addition to the transport path 18, a switchback path 19, and an inversion path 20 may extend in the recording device 11. The switchback path 19 and the inversion path 20 are used when images are recorded on both sides of the medium 99.

The switchback path 19 is a path through which the medium 99 is switched back, that is, a direction in which the medium 99 travels is inverted. The switchback path 19 extends so as to branch from the transport path 18. To the switchback path 19, the medium 99 on which an image is recorded on one side is transported.

The inversion path 20 is a path through which posture of the medium 99 is inverted. The inversion path 20 is coupled to the switchback path 19. The medium 99 switched back in the switchback path 19 is transported to the inversion path 20. The inversion path 20 is coupled to the transport path 18. When transported through the inversion path 20, the medium 99 is inverted in posture and is returned to the transport path 18. When transported through the transport path 18 again, an image is recorded on the medium 99 again. With this, the images are recorded on both the sides of the medium 99.

The recording device 11 includes a discharge tray 21. The discharge tray 21 receives the medium 99 after recording. Specifically, the discharge tray 21 receives the medium 99 discharged to the outside of the device main body 12 through the transport path 18. In one example, the discharge tray 21 is constituted by an exterior surface of the device main body 12.

The recording device 11 includes a transport unit 22. The transport unit 22 is configured to transport the medium 99. The transport unit 22 transports the medium 99 loaded on the loading unit 17. The transport unit 22 transports the medium 99 along the transport path 18. The transport unit 22 may transport the medium 99 along the switchback path 19 and the inversion path 20.

The transport unit 22 includes one or more rollers 23. In one example, the transport unit 22 includes the plurality of rollers 23. The plurality of rollers 23 are disposed, for example, at the transport path 18, the switchback path 19, the inversion path 20, and the like. The plurality of rollers 23 are attached to the device main body 12, the door 13, and the like.

The transport unit 22 includes a transport belt 24, a first pulley 25, and a second pulley 26. The transport belt 24 is wound around the first pulley 25 and the second pulley 26. The transport belt 24 adsorbs the medium 99 by electrostatic adsorption, for example. In this manner, the transport belt 24 supports the medium 99. The transport belt 24 may be configured to adsorb the medium 99 by suctioning the medium 99 with a negative pressure, for example. The first pulley 25 and the second pulley 26 are positioned along the transport path 18. When the first pulley 25 and the second pulley 26 rotate, the transport belt 24 rotates. As a result, the medium 99 supported by the transport belt 24 is transported. The transport belt 24 transports the medium 99 diagonally upward, for example. The recording device 11 may include a simple support instead of the transport belt 24.

The recording device 11 includes a recording unit 27. The recording unit 27 is configured to record an image on the medium 99. In one example, the recording unit 27 ejects liquid onto the medium 99 to record an image on the medium 99. The recording unit 27 is a line head that can eject liquid simultaneously over a width of the entire medium 99, for example. The recording unit 27 may be a serial head for scanning of the medium 99.

The recording unit 27 is positioned to face the transport belt 24, for example. The recording unit 27 is positioned diagonally above the transport belt 24. The recording unit 27 records an image on the medium 99 supported by the transport belt 24.

### Detection Device

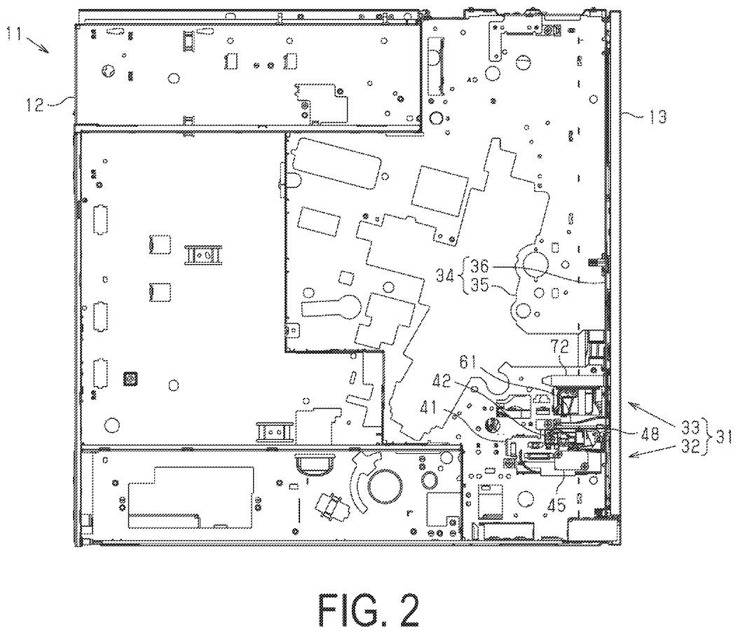

As illustrated in FIG. 2, the recording device 11 includes a detection device 31. The detection device 31 is configured to detect opening and closing of the door 13 with respect to the device main body 12. The detection device 31 is configured to, not only detect the opening and closing of the door 13, but also interrupt power supply. In one example, when the door 13 is opened, the detection device 31 interrupts the power supply to the transport unit 22. This reduces a possibility that the transport unit 22 is driven in a state where the door 13 is opened. When the door 13 is opened, the detection device 31 may interrupt the power supply not only to the transport unit 22 but also to other configurations.

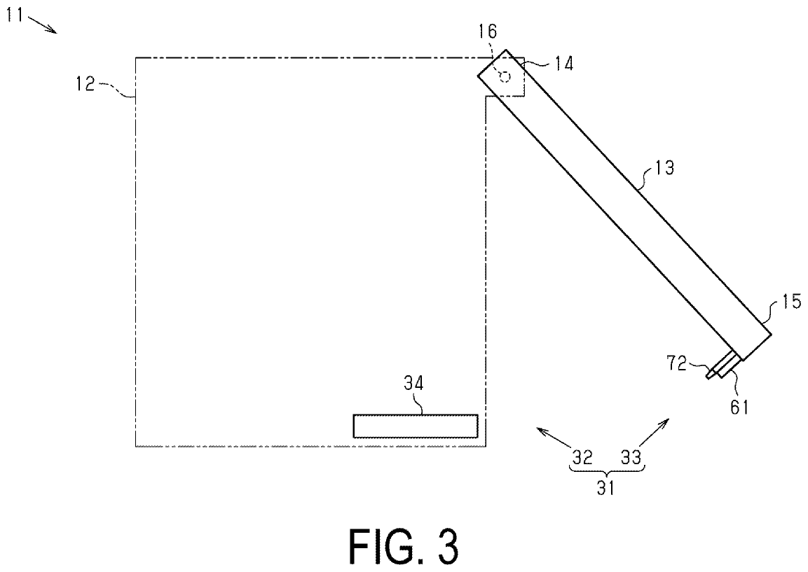

As illustrated in FIG. 3, the detection device 31 is attached to the device main body 12 and the door 13. The detection device 31 includes a main body portion 32 and a door portion 33. The main body portion 32 is a portion attached to the device main body 12. The door portion 33 is a portion attached to the door 13. Along with the opening and closing of the door 13, the door portion 33 enters the main body portion 32 or the door portion 33 retracts from the main body portion 32. When the door 13 is closed with respect to the device main body 12, the door portion 33 enters the main body portion 32. When the door 13 is opened with respect to the device main body 12, the door portion 33 retracts from the main body portion 32. When the door portion 33 retracts from the main body portion 32, the detection device 31 detects that the door 13 is opened and interrupts the power supply.

The door portion 33 is positioned at the distal end portion 15 of the door 13. The main body portion 32 is positioned, in the device main body 12, at a position facing the distal end portion 15 when the door 13 is closed. When the door portion 33 is positioned at the distal end portion 15, an amount of movement of the door portion 33 relative to an amount of rotation of the door 13 is greater than when the door portion 33 is positioned at the proximal portion 14. This makes it easy for the door portion 33 to enter and retract with respect to the main body portion 32. Further, when positioned at the distal end portion 15, the door portion 33 can linearly enter the main body portion 32. This is because the door 13 rotates about the rotational axis 16, and thus a movement locus of the door portion 33 accompanying the opening and closing of the door 13 draws an arc about the rotational axis 16. Since the door portion 33 is positioned at a position away from the rotational axis 16, a curvature of the arc drawn by the movement locus of the door portion 33 is reduced. Therefore, since the door portion 33 is positioned at the distal end portion 15, the door portion 33 can easily enter the main body portion 32 when the door 13 is closed.

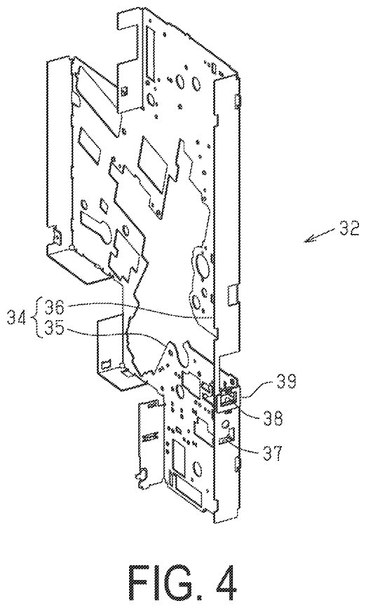

As illustrated in FIGS. 2 and 4, the main body portion 32 includes a frame 34. That is, the frame 34 is attached to the device main body 12. The frame 34 is formed of, for example, sheet metal. In one example, the frame 34 includes a holding portion 35 and a facing portion 36. The holding portion 35 is a portion that holds a sensor 42, a switch 45, and the like, which will be described later. The facing portion 36 is a portion facing the door portion 33 when the door 13 is closed. The facing portion 36 extends so as to bend from the holding portion 35.

As illustrated in FIG. 4, one or more insertion openings are formed at the facing portion 36. The insertion opening is an opening for the door portion 33 to enter the main body portion 32. The door portion 33 is inserted into the insertion opening. In one example, two insertion openings are formed at the facing portion 36. Specifically, a pressing insertion opening 37 and a pin insertion opening 38 are open at the facing portion 36.

The pressing insertion opening 37 and the pin insertion opening 38 are aligned in the vertical direction. In one example, the pressing insertion opening 37 is positioned below the pin insertion opening 38. The pressing insertion opening 37 may be positioned above the pin insertion opening 38. The pressing insertion opening 37 is an insertion opening into which a pressing member 61 described later is inserted. The pressing insertion opening 37 is open in accordance with a shape of the pressing member 61. In one example, the pressing insertion opening 37 is open in an L-shape. The pin insertion opening 38 is an insertion opening into which a positioning pin 72 is inserted. The pin insertion opening 38 is open in a rectangular shape, for example.

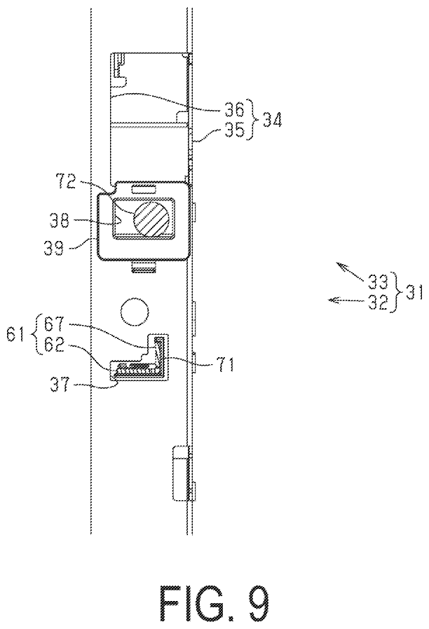

The main body portion 32 may include a protective member 39 (see FIG. 9). The protective member 39 is attached to the frame 34. Specifically, the protective member 39 is attached to the facing portion 36. The protective member 39 is attached to the facing portion 36 so as to surround the pin insertion opening 38. The protective member 39 is formed of a resin material. The protective member 39 is disposed so as to be able to support the positioning pin 72, to protect the frame 34 against the positioning pin 72. This reduces a possibility of wear of the frame 34, wear of the positioning pin 72, or wear of both of these components due to rubbing of the positioning pin 72 against the facing portion 36. As a result, wear of the frame 34 constituting the main body portion 32 can be reduced, and the frame 34 can be prevented from being replaced. Further, positional accuracy of the door 13, for example, in the vertical direction can be maintained over a long period of time. In addition, a possibility that abnormal noise is generated by the positioning pin 72 rubbing against the facing portion 36 is reduced.

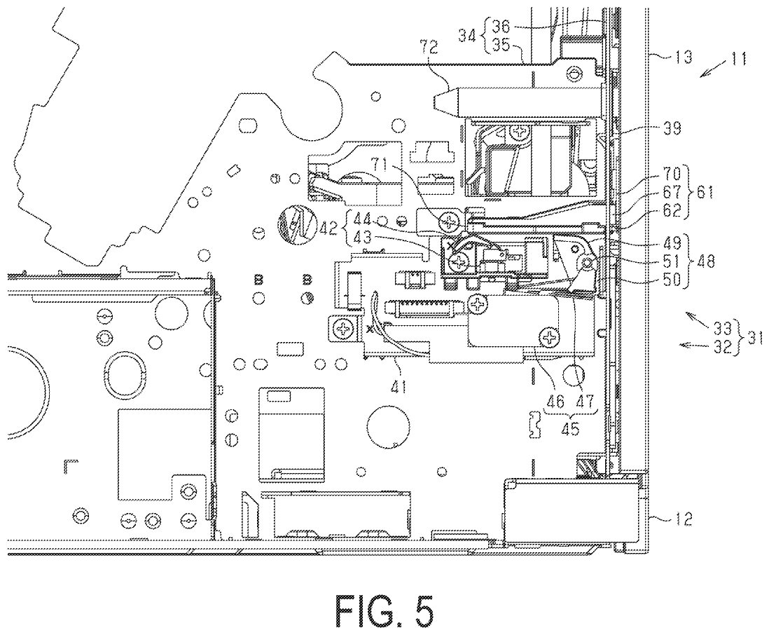

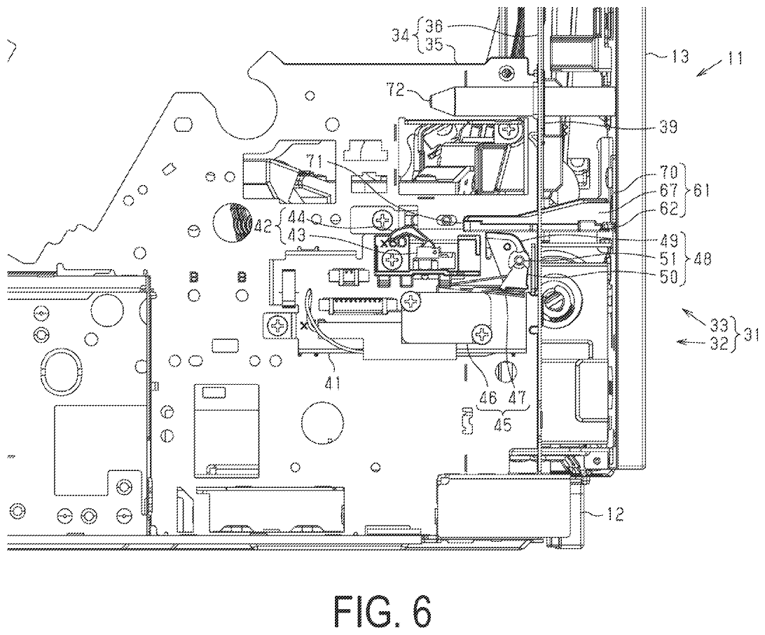

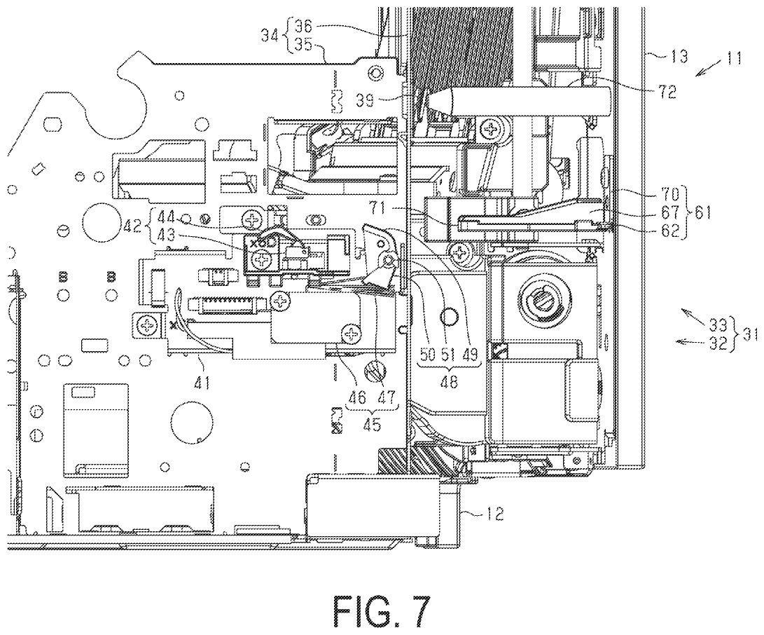

As illustrated in FIGS. 5, 6, and 7, the main body portion 32 includes an attachment plate 41. The attachment plate 41 is attached to the frame 34. Specifically, the attachment plate 41 is attached to the holding portion 35. The attachment plate 41 is a plate member for integrally handling the sensor 42, the switch 45, and the like.

The main body portion 32 includes the sensor 42. That is, the sensor 42 is attached to the device main body 12. Specifically, the sensor 42 is attached to the attachment plate 41. The sensor 42 may be directly attached to the holding portion 35. In a state where the door 13 is closed, the sensor 42 is positioned below or above the pressing member 61. In one example, the sensor 42 is positioned below the pressing member 61.

The sensor 42 is configured to detect the opening and closing of the door 13. The sensor 42 detects that the door 13 is closed by detecting the door portion 33. Specifically, the sensor 42 detects that the door 13 is closed by detecting the pressing member 61. In one example, the sensor 42 detects the pressing member 61 by coming into contact with the pressing member 61. The sensor 42 detects that the door 13 is closed by being pressed by the pressing member 61. The sensor 42 detects that the door 13 is opened when the pressing by the pressing member 61 is released.

The sensor 42 includes a sensor case 43 and an arm 44. The sensor case 43 is attached to the attachment plate 41. The arm 44 extends from the sensor case 43. The arm 44 extends from an upper portion of the sensor case 43 so as to be separated away from the door 13.

The sensor 42 is switched between on and off by the arm 44. When the arm 44 is pressed, the sensor 42 is on. At this time, the sensor 42 detects that the door 13 is closed. When the pressing of the arm 44 is released, the sensor 42 is off. At this time, the sensor 42 detects that the door 13 is opened.

When the door 13 is closed, the arm 44 comes into contact with the pressing member 61. At this time, the arm 44 is pressed downward by the pressing member 61. As a result, the arm 44 is displaced downward. The displacement of the arm 44 causes the sensor 42 to output a signal. In this way, the sensor 42 detects that the door 13 is closed. When the door 13 is opened, the arm 44 returns to an original position thereof. Thus, the sensor 42 detects that the door 13 is opened.

The main body portion 32 includes the switch 45. That is, the switch 45 is attached to the device main body 12. Specifically, the switch 45 is attached to the attachment plate 41. The switch 45 may be directly attached to the holding portion 35. In the state where the door 13 is closed, the switch 45 is positioned below or above the pressing member 61. In one example, the switch 45 is positioned below the pressing member 61. Specifically, the switch 45 is positioned below the sensor 42. The switch 45 may be positioned above the sensor 42, that is, between the pressing member 61 and the sensor 42 in the vertical direction.

The switch 45 is configured to interrupt the power supply. The switch 45 interrupts the power supply when the pressing by the pressing member 61 is released. For example, the switch 45 interrupts conduction between a power supply and the transport unit 22. When pressure is applied from the pressing member 61, the switch 45 electrically couples the power supply and the transport unit 22. That is, when the switch 45 is pressed by the pressing member 61, the power supply is started. When the pressing of the switch 45 by the pressing member 61 is released, the power supply is interrupted.

The switch 45 is positioned so as to correspond to a position of the sensor 42. Specifically, when the sensor 42 is positioned below the pressing member 61, the switch 45 is positioned below the pressing member 61. When the sensor 42 is positioned above the pressing member 61, the switch 45 is positioned above the pressing member 61. That is, the sensor 42 and the switch 45 are collectively positioned below or above the pressing member 61. Specifically, in the state where the door 13 is closed, the sensor 42 and the switch 45 are collectively positioned below or above the pressing member 61. In this case, both the sensor 42 and the switch 45 are driven by being pressed by a lower end or an upper end of the pressing member 61. Accordingly, an order in which the sensor 42 and the switch 45 are driven is easily secured. For example, when the sensor 42 is positioned below the pressing member 61, the switch 45 is positioned above the pressing member 61, and a position of the main body portion 32 is displaced with respect to the door portion 33, there is a possibility that one of the sensor 42 and the switch 45 is not pressed by the pressing member 61.

The switch 45 and the sensor 42 are positioned so as not to be driven at the same time. This is because when the sensor 42 and the switch 45 are driven at the same time, there is a risk that an element, a substrate, or the like to which electric power is supplied is damaged due to instantaneous interruption. Therefore, in the detection device 31, it is necessary to provide a time difference between the driving of the sensor 42 and the driving of the switch 45.

The switch 45 is positioned so as to be pressed by the pressing member 61 earlier than the sensor 42 when the door 13 is closed. For example, in the state where the door 13 is closed, a distance between the switch 45 and the door 13 is less than a distance between the sensor 42 and the door 13. Therefore, when the door 13 is closed, the power supply is started before the sensor 42 detects that the door 13 is closed. When the door 13 is opened, the pressing of the switch 45 by the pressing member 61 is released later than the sensor 42. Therefore, when the door 13 is opened, the power supply is interrupted after the sensor 42 detects that the door 13 is opened. This reduces the risk that the element, the substrate, or the like to which electric power is supplied is damaged due to the instantaneous interruption.

The switch 45 includes a switch case 46 and a lever 47. The switch case 46 is attached to the attachment plate 41. The lever 47 extends from the switch case 46. The lever 47 extends from an upper portion of the switch case 46 so as to approach the door 13. That is, the direction in which the lever 47 extends with respect to the switch case 46 is opposite to the direction in which the arm 44 extends with respect to the sensor case 43.

The switch 45 is switched between on and off by the lever 47. When the lever 47 is pressed, the switch 45 is on.

At this time, the power supply is started. When the pressing of the lever 47 is released, the switch 45 is off. At this time, the power supply is interrupted.

The lever 47 is pressed by the pressing member 61 when

the door 13 is closed. Specifically, when the door 13 is closed, the lever 47 is pressed downward by the pressing member 61. As a result, the lever 47 is displaced downward. When the lever 47 is pressed, the power supply is started. When the door 13 is opened, the lever 47 returns to an original position thereof. That is, when the pressing of the lever 47 is released, the switch 45 interrupts the power supply.

The sensor 42 and the switch 45 are positioned so as to overlap each other when viewed from the vertical direction. That is, when viewed from the vertical direction, at least a part of the sensor 42 overlaps the switch 45, or at least a part of the switch 45 overlaps the sensor 42. In other words, the position of the sensor 42 in the horizontal direction and the position of the switch 45 in the horizontal direction overlap each other. Accordingly, as compared to a case where the sensor 42 and the switch 45 are aligned in the horizontal direction, a possibility of resulting in large sizes in the horizontal direction of the detection device 31 and the recording device 11 is reduced. In one example, when viewed from the vertical direction, the sensor 42 and the switch 45 are positioned such that the sensor case 43 and the switch case 46 overlap each other. On the other hand, when viewed from the vertical direction, the sensor 42 and the switch 45 are positioned such that a tip of the lever 47 does not overlap the sensor 42. Thus, the lever 47 is easily pressed by the pressing member 61.

The main body portion 32 includes a link member 48. That is, the link member 48 is attached to the device main body 12. Specifically, the link member 48 is attached to the attachment plate 41. The link member 48 may be directly attached to the holding portion 35.

The link member 48 is a member that comes into contact with the pressing member 61. The link member 48 comes into contact with the pressing member 61 when the door 13 is closed. The link member 48 is displaced by coming into contact with the pressing member 61. The link member 48 is displaced to press the switch 45. Specifically, the link member 48 presses the lever 47 by being contacted by the pressing member 61. Therefore, the switch 45 is pressed by the pressing member 61. In this case, as compared to a case where the main body portion 32 does not include the link member 48, the pressing member 61 does not need to directly press the switch 45, and thus a degree of freedom in disposition of the switch 45 is improved. The lever 47 may be directly pressed by the switch 45 by the pressing member 61. In this case, for example, the tip of the lever 47 may extend so as to bend toward the pressing member 61.

The link member 48 includes a first contact portion 49 and a second contact portion 50. The first contact portion 49 is a portion that comes into contact with the pressing member 61. The first contact portion 49 is pressed downward by the pressing member 61. The second contact portion 50 is a portion that comes into contact with the lever 47. The second contact portion 50 is displaced downward when the first contact portion 49 is displaced.

The link member 48 includes a shaft 51 serving as a center of rotation. The link member 48 is displaced by rotating about the shaft 51. When the pressing member 61 comes into contact with the first contact portion 49, the link member 48 rotates so that the second contact portion 50 presses the lever 47 downward.

The link member 48 is aligned with the sensor 42 in the horizontal direction. Specifically, when the door 13 is closed, the link member 48 and the sensor 42 are aligned in the horizontal direction so as to be contacted by the pressing member 61 in this order. Therefore, in the state where the door 13 is closed, a distance between the link member 48 and the door 13 is less than the distance between the sensor 42 and the door 13. When the door 13 is closed, and the link member 48 comes into contact with the pressing member 61 before the sensor 42 comes into contact with the pressing member 61, a time difference can be provided between the driving of the sensor 42 and the driving of the switch 45.

The link member 48 may be configured to be contacted by the pressing member 61 to press the arm 44, instead of the lever 47. Further, the main body portion 32 may also include the two link members 48. In this case, for example, the main body portion 32 may include the link member 48 that presses the arm 44 and the link member 48 that presses the lever 47.

The door portion 33 includes the pressing member 61. That is, the pressing member 61 is attached to the door 13. The pressing member 61 is a protrusion extending from the door 13 toward the device main body 12. The pressing member 61 presses the switch 45. In one example, the pressing member 61 presses the sensor 42 and the switch 45. Specifically, the pressing member 61 directly presses the sensor 42, and indirectly presses the switch 45 via the link member 48. The pressing member 61 is, for example, a protrusion extending from the door 13 toward the device main body 12.

The pressing member 61 enters the main body portion 32 when the door 13 is closed. Specifically, the pressing member 61 enters the frame 34. In one example, the pressing member 61 is inserted into the pressing insertion opening 37. At this time, the pressing member 61 presses the switch 45 and the sensor 42 in this order. The pressing member 61 retracts from the main body portion 32 when the door 13 is opened. Specifically, the pressing member 61 retracts from the frame 34. At this time, the pressing member 61 releases the pressing in an order of the sensor 42 and the switch 45.

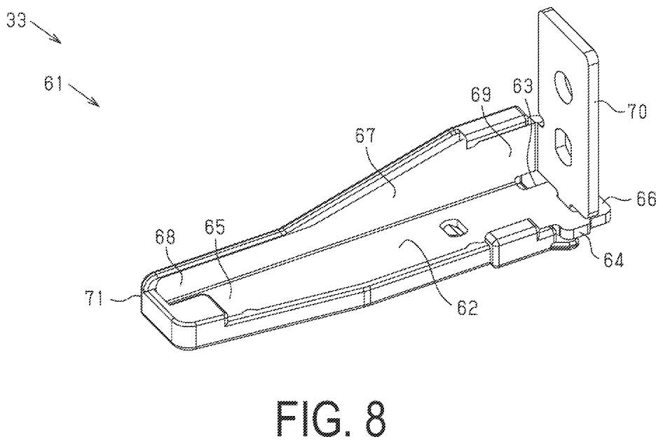

As illustrated in FIG. 8, the pressing member 61 includes a pressing portion 62. The pressing portion 62 is a portion that presses the switch 45. In one example, the pressing portion 62 presses the sensor 42 and the switch 45. Specifically, a lower surface of the pressing portion 62 comes into contact with the sensor 42 and the link member 48 to press the sensor 42 and the switch 45.

The pressing portion 62 includes a first side end 63 and a second side end 64. The first side end 63 and the second side end 64 are side ends of the pressing portion 62 in the direction in which the pressing member 61 extends. A distance between the first side end 63 and the rotational axis 16 is less than a distance between the second side end 64 and the rotational axis 16. That is, in a movement locus of the pressing member 61 that draws an arc about the rotational axis 16, the first side end 63 is a side end that faces inward, and the second side end 64 is a side end that faces outward.

The pressing portion 62 includes a pressing distal end 65 and a pressing proximal end 66. The pressing distal end 65 and the pressing proximal end 66 are end portions of the pressing portion 62 in the direction in which the pressing member 61 extends. A distance between the pressing distal end 65 and the door 13 is greater than a distance between the pressing proximal end 66 and the door 13.

In the pressing portion 62, a cross-sectional area of the pressing distal end 65 is less than a cross-sectional area of the pressing proximal end 66. In one example, the pressing portion 62 extends so as to be increased in cross-sectional area as viewed from the pressing distal end 65 to the pressing proximal end 66. That is, the pressing portion 62 has a tapered shape. Thus, an opening area of the pressing insertion opening 37 can be reduced. If the pressing portion 62 extends so as to be uniform in cross-sectional area as viewed from the pressing distal end 65 to the pressing proximal end 66, the opening area of the pressing insertion opening 37 becomes large. This is because the pressing insertion opening 37 needs to be open so as to correspond to a movement locus of the pressing portion 62 which moves so as to draw an arc about the rotational axis 16.

The pressing member 61 includes a vertical portion 67. The vertical portion 67 is a portion extending vertically from the pressing portion 62. In one example, the vertical portion 67 extends upward from the pressing portion 62. The vertical portion 67 may extend downward from the pressing portion 62. Rigidity of the pressing member 61 is ensured by the vertical portion 67. The pressing member 61 is formed in an L-shape by the pressing portion 62 and the vertical portion 67.

The vertical portion 67 extends vertically from the first side end 63 in the pressing portion 62. That is, the vertical portion 67 extends from a side end, of the two side ends included in the pressing portion 62, that is close to the rotational axis 16. Accordingly, the opening area of the pressing insertion opening 37 can be reduced, as compared to a case where the vertical portion 67 extends from the second side end 64.

The vertical portion 67 includes a vertical distal end 68 and a vertical proximal end 69. The vertical distal end 68 and the vertical proximal end 69 are end portions of the vertical portion 67 with respect to the direction in which the pressing member 61 extends. A distance between the vertical distal end 68 and the door 13 is greater than a distance between the vertical proximal end 69 and the door 13.

In the vertical portion 67, a cross-sectional area of the vertical distal end 68 is less than a cross-sectional area of the vertical proximal end 69. Specifically, the vertical portion 67 extends so as to be increased in cross-sectional area as viewed from the vertical distal end 68 to the vertical proximal end 69. That is, the vertical portion 67 has a tapered shape. Thus, an opening area of the pressing insertion opening 37 can be reduced.

The pressing member 61 includes an attachment portion 70. The attachment portion 70 is a portion attached to the door 13. The attachment portion 70 faces the door 13. In one example, the attachment portion 70 extends vertically with respect to the pressing portion 62.

The pressing member 61 is formed of sheet metal. Specifically, the pressing member 61 is formed of a bent sheet metal. In one example, the vertical portion 67 extends so as to be bent from the pressing portion 62, and the attachment portion 70 extends so as to be bent from the vertical portion 67.

The door portion 33 may include a cover member 71. The cover member 71 is attached to the pressing member 61. The cover member 71 is attached so as to cover the pressing member 61. Specifically, the cover member 71 covers an edge of the pressing member 61. In one example, the cover member 71 covers edges of the pressing portion 62 and the vertical portion 67. The cover member 71 is formed of a resin material. Accordingly, for example, a possibility that a user's hand touches the edge of the pressing member 61 is reduced. Further, the pressing member 61 is protected by the cover member 71.

As illustrated in FIGS. 5, 6, and 7, the door portion 33 may include the positioning pin 72. That is, the positioning pin 72 is attached to the door 13. The positioning pin 72 is a pin that enters the main body portion 32 when the door 13 is closed. Specifically, the positioning pin 72 enters the frame 34. In one example, the positioning pin 72 is inserted into the pin insertion opening 38. Thus, the positioning pin 72 positions the pressing member 61 with respect to the frame 34. Since the pressing member 61 is positioned with respect to the frame 34, the pressing member 61 can accurately press the sensor 42 and the switch 45. That is, driving accuracy of the sensor 42 and the switch 45 is improved.

The positioning pin 72 is a pin formed of metal. The positioning pin 72 has a tapered shape. For example, a tip of the positioning pin 72 has a conical shape. Thus, the tip of the positioning pin 72 is easily inserted into the pin insertion opening 38. That is, even when the door 13 is opened, for example, and the door 13 moves downward due to own weight thereof, a possibility that the tip of the positioning pin 72 collides with the facing portion 36 with respect to the pin insertion opening 38 is reduced. In other words, a possibility that the door 13 cannot be closed is reduced. Further, since the positioning pin 72 has the tapered shape, a movement locus of the tip end of the positioning pin 72 accompanying the opening and closing of the door 13 becomes small, so that an opening area of the pin insertion opening 38 can be reduced. For example, rigidity of the frame 34 can be increased by reducing the opening area of the pin insertion opening 38. This reduces a possibility of deformation of the frame 34, the device main body 12, and the like.

A length of the positioning pin 72 is greater than a length of the pressing member 61. Therefore, when the door 13 is closed, the positioning pin 72 is inserted into the pin insertion opening 38 before the pressing member 61 is inserted into the pressing insertion opening 37. That is, after being positioned by the positioning pin 72, the pressing member 61 is inserted into the pressing insertion opening 37. Thus, the sensor 42 and the switch 45 are pressed by the pressing member 61, after the door 13 is positioned in the vertical direction by the insertion of the positioning pin 72. Since the pressing member 61 is positioned with respect to the sensor 42 and the switch 45 by the positioning pin 72, it is possible to accurately drive the sensor 42 and the switch 45. That is, variations in driving timing of the sensor 42 and driving timing of the switch 45 are reduced. For example, when the door 13 is closed, it is possible to reduce variations in time from when the switch 45 is driven to when the sensor 42 is driven. In other words, it is possible to reliably ensure a time difference between the time when the switch 45 is driven and the time when the sensor 42 is driven.

As illustrated in FIG. 9, the positioning pin 72 is positioned so as to overlap the pressing member 61 as viewed from the vertical direction. Thus, the detection device 31 and the recording device 11 can be reduced in size in the horizontal direction. In one example, the positioning pin 72 is positioned above the pressing member 61. The positioning pin 72 may be positioned below the pressing member 61.

### Operation and Effects

Next, actions and effects of the example described above are described.
(1) The sensor 42 and the switch 45 are positioned above or below the pressing member 61 in the state where the door 13 is closed. The sensor 42 and the switch 45 are positioned so as to overlap each other when viewed from the vertical direction. According to the above-described configuration, installation spaces for the sensor 42 and the switch 45 required in the horizontal direction are small as compared to a case where the sensor 42 and the switch 45 do not overlap each other. Thus, the detection device 31 and the recording device 11 can be reduced in size in the horizontal direction.
(2) The link member 48 and the sensor 42 are aligned so as to come into contact with the pressing member 61 in this order when the door 13 is closed. According to the above- described configuration, the link member 48 improves a degree of freedom in a disposition of the switch 45 as compared with a case where the pressing member 61 directly contacts the switch 45.
(3) When the door 13 is closed, the positioning pin 72 is inserted into the frame 34 to position the pressing member 61 with respect to the frame 34. With the above-described configuration, a position shift of the pressing member 61 is less likely to occur, and thus the driving accuracy of the sensor 42 and the switch 45 is improved.
(4) The length of the positioning pin 72 is greater than the length of the pressing member 61. According to the above-described configuration, the positioning pin 72 is inserted into the frame 34 earlier than the pressing member 61. That is, after being positioned by the positioning pin 72, the pressing member 61 is inserted into the frame 34. Accordingly, the pressing member 61 is inserted into the frame 34 in a state of being positioned with respect to the sensor 42 and the switch 45. Therefore, it is possible to accurately drive the sensor 42 and the switch 45.
(5) The positioning pin 72 is positioned so as to overlap the pressing member 61 when viewed from the vertical direction. According to the above-described configuration, it is possible to reduce the detection device 31 and the recording device 11 in size in the horizontal direction.
(6) The pressing insertion opening 37 is open in accordance with the shape of the pressing member 61 formed by the pressing portion 62 and the vertical portion 67. According to the above-described configuration, for example, the opening area of the pressing insertion opening 37 can be reduced as compared to a case where the pressing insertion opening 37 is open in a rectangular shape so as to surround the pressing member 61. This reduces a possibility that a user's finger accidentally enters the pressing insertion opening 37.
(7) The pressing member 61 is formed of a bent metal plate. According to the above-described configuration, rigidity of the pressing member 61 can be secured.
(8) The cover member 71 is formed of a resin material. According to the above-described configuration, the pressing member 61 can be protected by the cover member 71. This reduces a possibility that the pressing member 61 wears out. In addition, the possibility that the user's hand touches the edge of the pressing member 61 is reduced.
(9) The vertical portion 67 extends from the first side end 63. According to the above-described configuration, the opening area of the pressing insertion opening 37 can be made smaller as compared to a case where the vertical portion 67 extends from the second side end 64. This reduces the possibility that the user's finger accidentally enters the pressing insertion opening 37.
(10) The cross-sectional area of the pressing distal end 65 is less than the cross-sectional area of the pressing proximal end 66. The cross-sectional area of the vertical distal end 68 is less than the cross-sectional area of the vertical proximal end 69. According to the above-described configuration, the pressing member 61 has a shape tapered from a distal end to a proximal end. As compared to a case where the pressing member 61 is uniform in cross-sectional area from the distal end to the proximal end, the opening area of the pressing insertion opening 37 can be reduced.
(11) The detection device 31 includes the protective member 39 that protects the frame 34 against the positioning pin 72 to be inserted into the frame 34. According to the above- described configuration, when the positioning pin 72 is inserted into the frame 34, a possibility that the positioning pin 72 comes into contact with the frame 34 is reduced. Thus, noise due to friction between the positioning pin 72 and the frame 34, wear due to the friction between the positioning pin 72 and the frame 34, and the like are reduced.
(12) When the door 13 is opened with respect to the device main body 12, the pressing member 61 is separated from the switch 45 after being separated from the sensor 42. When the door 13 is closed with respect to the device main body 12, the pressing member 61 presses the sensor 42 after pressing the switch 45. When the pressing member 61 is separated from the sensor 42 after being separated from the switch 45 when the door 13 is opened, there is a possibility that an overcurrent due to an instantaneous interruption occurs. Therefore, according to the above-described configuration, the possibility that the overcurrent due to the instantaneous interruption occurs is reduced.

### Modified Examples

The above embodiment can be modified and implemented as follows. The above embodiments and the following modification examples can be implemented in combination with each other within a technically consistent range.

The sensor 42 is not limited to a contact sensor and may be, for example, an optical sensor. The sensor 42 may detect the pressing member 61 by being light-shielded by the pressing member 61. The sensor 42 detects that the door 13 is closed by detecting the pressing member 61.

The liquid ejected from the recording unit 27 is not limited to ink, and may be, for example, a liquid material including particles of a functional material dispersed or mixed in a liquid, or the like. For example, the recording unit 27 may eject a liquid material including a material such as an electrode material or a pixel material used in manufacture of a liquid crystal display, an electroluminescent (EL) display, and a surface emitting display in a dispersed or dissolved form.

### Technical Spirit

Hereinafter, technical spirit and effects thereof ascertained from the above-described embodiments and modification examples will be described.

(A) A detection device is a detection device that detects opening and closing of a door with respect to a device main body, including a pressing member attached to the door, a sensor attached to the device main body, and configured to detect that the door is closed by detecting the pressing member, and a switch attached to the device main body, and configured to interrupt power supply when pressing by the pressing member is released, wherein the sensor and the switch are positioned above or below the pressing member in a state where the door is closed, and are positioned so as to overlap each other when viewed from a vertical direction. According to the above- described configuration, installation spaces for the sensor and the switch required in the horizontal direction are small as compared to a case where the sensor and the switch do not overlap each other. Thus, a size of the detection device can be reduced in the horizontal direction.

(B) The above-described detection device may include a link member attached to the device main body and contacted by the pressing member, wherein the sensor may detect that the door is closed by being pressed by the pressing member, the switch may include a lever, and interrupt power supply when pressing of the lever is released, the link member may press the lever by being contacted by the pressing member, and the link member and the sensor may be aligned so as to come into contact with the pressing member in this order when the door is closed. According to the above-described configuration, a degree of freedom in disposition of the switch is improved by the link member as compared to a case where the pressing member directly contacts the switch.

(C) The above-described detection device may include a frame that is attached to the device main body and configured to hold the sensor and the switch, and a positioning pin that is attached to the door, wherein when the door is closed, the positioning pin may be inserted into the frame to position the pressing member with respect to the frame. According to the above-described configuration, since a position shift of the pressing member is less likely to occur, driving accuracy of the sensor and the switch is improved.

(D) In the above-described detection device, a length of the positioning pin may be greater than a length of the pressing member. According to the above-described configuration, the positioning pin is inserted into the frame before the pressing member. That is, the pressing member is inserted into the frame after being positioned by the positioning pin. Accordingly, the pressing member is inserted into the frame in a state of being positioned with respect to the sensor and the switch. Therefore, the sensor and the switch can be driven with high accuracy.

(E) In the above-described detection device, the positioning pin may be positioned so as to overlap the pressing member when viewed from the vertical direction. According to the above-described configuration, it is possible to reduce the size of the detection device in the horizontal direction.

(F) In the above-described detection device, the sensor may detect that the door is closed by being pressed by the pressing member, an insertion opening into which the pressing member is inserted may be open at the frame, the pressing member may include a pressing portion that presses the sensor and the switch, and a vertical portion that extends vertically from the pressing portion, and press the sensor and the switch by being inserted into the insertion opening, and the insertion opening may be open in accordance with a shape of the pressing member formed by the pressing portion and the vertical portion. According to the above-described configuration, for example, an opening area of the insertion opening can be reduced as compared to a case where the insertion opening is open in a rectangular shape so as to surround the pressing member. This reduces a possibility of a user's finger accidentally entering the insertion opening.

(G) In the above-described detection device, the pressing member may be formed of a bent sheet metal. According to the above-described configuration, rigidity of the pressing member can be secured.

(H) The above-described detection device may include a cover member configured to cover the pressing member, wherein the cover member may be formed of a resin material. According to the above-described configuration, the pressing member can be protected by the cover member. This reduces a possibility that a user's hand touches an edge of the pressing member.

(I) In the above-described detection device, the door may be opened and closed by rotating about a rotational axis, the pressing portion may include a first side end and a second side end, a distance between the first side end and the rotational axis may be less than a distance between the second side end and the rotational axis, and the vertical portion may extend from the first side end. According to the above- described configuration, the opening area of the insertion opening can be reduced as compared to a case where the vertical portion extends from the second side end. This reduces the possibility of the user's finger accidentally entering the insertion opening.

(J) In the above-described detection device, the pressing portion may include a pressing proximal end and a pressing distal end, a distance between the pressing distal end and the door may be greater than a distance between the pressing proximal end and the door, the vertical portion may include a vertical proximal end and a vertical distal end, a distance between the vertical distal end and the door may be greater than a distance between the vertical proximal end and the door, a cross-sectional area of the pressing distal end may be less than a cross-sectional area of the pressing proximal end, and a cross-sectional area of the vertical distal end may be less than a cross-sectional area of the vertical proximal end. According to the above-described configuration, the pressing member has a shape tapered from a distal end to a proximal end. As compared to a case where the pressing member is uniform in cross- sectional area as viewed from the distal end to the proximal end, the opening area of the insertion opening can be reduced.

(K) The above-described detection device may include a protective member configured to protect the frame against the positioning pin to be inserted into the frame. According to the above-described configuration, when the positioning pin is inserted into the frame, a possibility that the positioning pin comes into contact with the frame is reduced. As a result, abnormal noise due to friction between the positioning pin and the frame, wear due to the friction between the positioning pin and the frame, and the like are reduced. Further, a life of the frame can be extended.

(L) In the above-described detection device, the sensor may detect that the door is closed by being pressed by the pressing member, and the pressing member may be separated from the switch after being separated from the sensor when the door is opened with respect to the device main body, and may press the sensor after pressing the switch when the door is closed with respect to the device main body. When the pressing member is separated from the sensor after being separated from the switch when the door is opened, there is a possibility that an overcurrent due to an instantaneous interruption occurs. Therefore, according to the above-described configuration, the possibility that the overcurrent due to the instantaneous interruption occurs is reduced.

(M) A recording device includes the above-described detection device, the device main body, and the door. According to the above-described configuration, the same effects as those of the detection device described above can be obtained.

What is claimed is:

1. A detection device that detects opening and closing of a door with respect to a device main body, comprising:
a pressing member attached to the door;
a sensor attached to the device main body, and configured to detect that the door is closed, by detecting the pressing member; and
a switch attached to the device main body, and configured to interrupt power supply when pressing by the pressing member is released, wherein
the sensor and the switch are
positioned above or below the pressing member in a state where the door is closed, and
positioned so that the sensor and the switch overlap when viewed from a vertical direction.

2. The detection device according to claim 1, comprising a link member that is attached to the device main body and comes into contact with the pressing member, wherein
the sensor detects that the door is closed, by being pressed by the pressing member,
the switch
includes a lever, and
interrupts power supply when pressing of the lever is released,
the link member presses the lever by being contacted by the pressing member, and
the link member and the sensor are aligned so as to come into contact with the pressing member in this order when the door is closed.

3. The detection device according to claim 1, comprising:
a frame that is attached to the device main body, and configured to hold the sensor and the switch; and
a positioning pin attached to the door, wherein
when the door is closed, the positioning pin is inserted into the frame to position the pressing member with respect to the frame.

4. The detection device according to claim 3, wherein
a length of the positioning pin is greater than a length of the pressing member.

5. The detection device according to claim 3, wherein
the positioning pin is positioned so as to overlap the pressing member when viewed from the vertical direction.

6. The detection device according to claim 3, wherein
the sensor detects that the door is closed by being pressed by the pressing member,
an insertion opening into which the pressing member is inserted is open at the frame,
the pressing member
includes a pressing portion that presses the sensor and the switch, and a vertical portion that extends vertically from the pressing portion, and
presses the sensor and the switch by being inserted into the insertion opening, and
the insertion opening is open in accordance with a shape of the pressing member formed by the pressing portion and the vertical portion.

7. The detection device according to claim 1, wherein
the pressing member is formed of a bent metal plate.

8. The detection device according to claim 7, comprising a cover member configured to cover the pressing member, wherein
the cover member is formed of a resin material.

9. The detection device according to claim 6, wherein
the door is opened and closed by rotating about a rotational axis,
the pressing portion includes a first side end and a second side end,
a distance between the first side end and the rotational axis is less than a distance between the second side end and the rotational axis, and
the vertical portion extends from the first side end.

10. The detection device according to claim 9, wherein
the pressing portion includes a pressing proximal end and a pressing distal end,
a distance between the pressing distal end and the door is greater than a distance between the pressing proximal end and the door,
the vertical portion includes a vertical proximal end and a vertical distal end,
a distance between the vertical distal end and the door is greater than a distance between the vertical proximal end and the door,
a cross-sectional area of the pressing distal end is less than a cross-sectional area of the pressing proximal end, and
a cross-sectional area of the vertical distal end is less than a cross-sectional area of the vertical proximal end.

11. The detection device according to claim 3, comprising a protective member configured to protect the frame against the positioning pin to be inserted into the frame.

12. The detection device according to claim 1, wherein the sensor detects that the door is closed by being pressed by the pressing member, and
the pressing member
is separated from the switch after being separated from the sensor when the door is opened with respect to the device main body, and
presses the sensor after pressing the switch when the door is closed with respect to the device main body.

13. A recording device, comprising:
the detection device according to claim 1;
the device main body; and
the door.
